(19) United States
(12) Patent Application Publication
(10) Pub. No.: US 2015/0019773 A1
(43) Pub. Date: Jan. 15, 2015

(54) SIGNAL PROCESSING APPARATUS

(71) Applicant: HON HAI PRECISION INDUSTRY CO., LTD., New Taipei (TW)

(72) Inventor: CHUN-LIANG LEE, New Taipei (TW)

(21) Appl. No.: 14/325,669

(22) Filed: Jul. 8, 2014

(30) Foreign Application Priority Data
Jul. 11, 2013 (TW) 102124828

(51) Int. Cl. G06F 13/40; G06F 13/42

(52) U.S. Cl. CPC G06F 13/4022; G06F 13/4282
USPC 710/106

(57) ABSTRACT

A signal processing apparatus includes a switch, a signal conditioner, and multiple storage units. Each of the storage units stores a set of signal transmission parameters in compliance with a communication protocol. The switch selects one of the storage units and connects the signal conditioner to the selected storage unit. The signal conditioner retrieves a set of signal transmission parameters from the selected storage unit. The signal conditioner receives a data signal from a transmitter, conditions the data signal according to the retrieved set of signal transmission parameters, and transmits the conditioned data signal to a receiver. A signal processing method is also disclosed.

### CROSS-REFERENCE TO RELATED APPLICATIONS

This application claims priority to Taiwan Patent Application No. 102124828 filed on Jul. 11, 2013 in the Taiwan Intellectual Property Office, the contents of which are hereby incorporated by reference. Relevant subject matter is disclosed in co-pending U.S. patent applications entitled “SIGNAL PROCESSING APPARATUS”, Attorney Docket Number US51819, US Application No. [to be advised], filed on the same day as the present application, and co-pending U.S. patent applications entitled “SIGNAL PROCESSING APPARATUS”, Attorney Docket Number US52017, US Application No. [to be advised], filed on the same day as the present application.

### FIELD

The disclosure generally relates to signal processing apparatuses, and more particularly relates to signal processing apparatuses having a signal conditioner.

### BACKGROUND

Serial communications/interconnect protocols provide efficient mechanisms to communicate between different devices. These protocols can include standards that define signal properties, timing, and state changes required for compatibility with the protocol. Upstream chips may have a limited drive capability, limiting the distance that signals may be safely transmitted.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an embodiment of a signal processing apparatus.

FIG. 2 is a flowchart of an embodiment of a signal processing method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

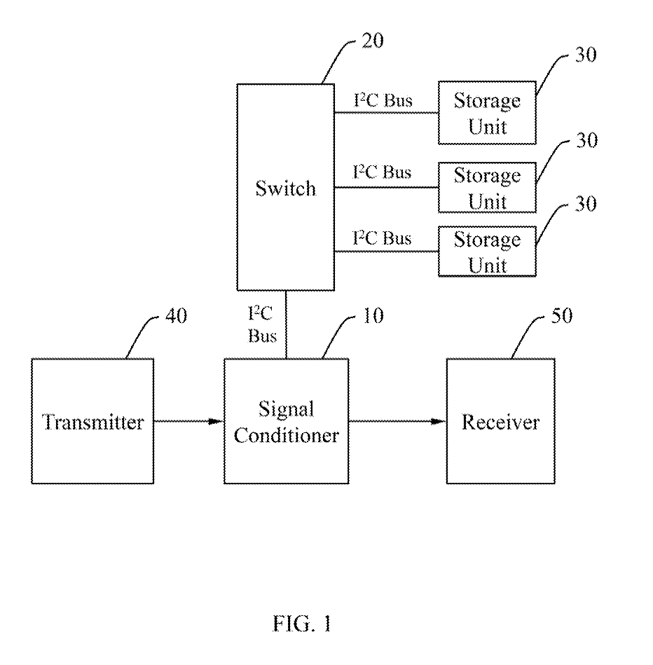

FIG. 1 illustrates a block diagram of an embodiment of a signal processing apparatus. The signal processing apparatus includes a signal conditioner 10, a switch 20, a plurality of storage units 30. The signal conditioner 10 is electrically connected to the switch 20. Each of the storage units 30 is connected to the switch 20.

Each of the storage units 30 stores a set of signal transmission parameters in compliance with a communication protocol, such as the universal serial bus (USB) protocol, the peripheral component interface express (PCIe) protocol, or the small computer system interface (SCSI) protocol. A set of signal transmission parameters can include a variety of parameters, e.g., I/O de-emphasis, slew rate, amplitude, DFE TAP, and/or other parameters regarding signal transmission. In at least one embodiment, each of the plurality of the storage units 30 is an EEPROM.

The switch 20 can select one of the plurality of storage units 30 and connect the signal conditioner 10 to the selected storage unit 30. The switch 20 may include one or more multiplexers or de-multiplexers for selecting one of the storage units 30 and connecting the signal conditioner 10 to the selected storage unit 30.

In at least one embodiment, the signal conditioner 10 is connected to the switch 20 via an inter-integrated circuit (I²C) bus, and each of the plurality of storage units 30 is connected to the switch 20 via an I²C bus. An I²C bus uses only two bidirectional lines, a serial data line (SDA) and a serial clock line (SCL), pulled up with resistors.

When the switch 20 connects the signal conditioner 10 to a selected storage unit 30, the signal conditioner 10 can retrieve a set of signal transmission parameters from the selected storage unit 30. The signal conditioner 10 can receive a data signal from a transmitter 40, such as a PCIe transmitter. The signal conditioner 10 can perform actions of conditioning the data signal, e.g., re-timing and/or repeating the data signal, according to the retrieved signal transmission parameters. The signal conditioner 10 can transmit the conditioned data signal to a receiver 50, such as a PCIe receiver.

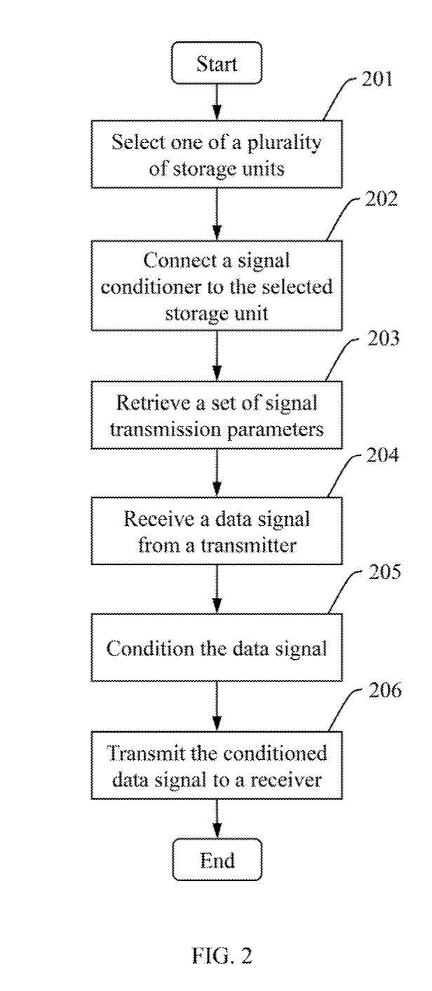

FIG. 2 shows a flowchart of one embodiment of a signal processing method. The method includes the following steps.

In block 201, the switch 20 selects one of the plurality of storage units 30.

In block 202, the switch 20 connects the signal conditioner 10 to the selected storage unit 30.

In block 203, the signal conditioner 10 retrieves a set of signal transmission parameters from the selected storage unit 30.

In block 204, the signal conditioner 10 receives a data signal from a transmitter 40, such as a PCIe transmitter.

In block 205, the signal conditioner 10 performs actions of conditioning the data signal, e.g., re-timing and/or repeating the data signal, according to the retrieved signal transmission parameters.

In block 206, the signal conditioner 10 transmits the conditioned data signal to a receiver 50, such as a PCIe receiver.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

Although numerous characteristics and advantages have been set forth in the foregoing description of embodiments, together with details of the structures and functions of the embodiments, the disclosure is illustrative only, and changes may be made in detail, including in the matters of arrangement of parts within the principles of the disclosure. The disclosed embodiments are illustrative only, and are not intended to limit the scope of the following claims.

What is claimed is:

1. A signal processing apparatus, comprising:
a switch;
a signal conditioner connected to the switch and configured to receive a data signal from a transmitter; and
a plurality of storage units connected to the switch, each of the storage units storing a set of signal transmission parameters in compliance with a communication protocol;
wherein the switch is configured to select one of the plurality of storage unit and to connect the signal conditioner to the selected storage unit, and the signal conditioner is configured to retrieve a set of signal transmission parameters from the selected storage unit, to condition the data signal according to the retrieved set of signal transmission parameters, and to transmit the conditioned data signal to a receiver.

2. The signal processing apparatus of claim 1, wherein the switch comprises a multiplexer or a de-multiplexer.

3. The signal processing apparatus of claim 1, wherein the signal conditioner is configured to re-time or repeat the data signal or both.

4. The signal processing apparatus of claim 1, wherein each of the plurality of storage units is an electrically erasable programmable read-only memory (EEPROM).

5. The signal processing apparatus of claim 1, wherein the signal conditioner is connected to the switch via an inter-integrated circuit (I²C) bus.

6. The signal processing apparatus of claim 1, wherein each of the plurality of storage units is connected to the switch via an I²C bus.

7. A signal processing method, comprising:
providing a switch, a signal conditioner connected to the switch, and a plurality of storage units connected to the switch, each of the storage units storing a set of signal transmission parameters in compliance with a communication protocol;
selecting one of the plurality of storage unit and connecting the signal conditioner to the selected storage unit by the switch;
retrieving a set of signal transmission parameters from the selected storage unit by the signal conditioner;
receiving a data signal from a transmitter by the signal conditioner;
conditioning the data signal according to the retrieved set of signal transmission parameters by the signal conditioner; and
transmitting the conditioned data signal to a receiver by the signal conditioner.

8. The signal processing method of claim 7, wherein the switch comprises a multiplexer or a de-multiplexer.

9. The signal processing method of claim 7, wherein the step of conditioning the data signal comprises re-timing and/or repeating the data signal by the signal conditioner.

10. The signal processing method of claim 7, wherein each of the plurality of storage units is an electrically erasable programmable read-only memory (EEPROM).

11. The signal processing method of claim 7, wherein the signal conditioner is connected to the switch via an inter-integrated circuit (I²C) bus.

12. The signal processing method of claim 7, wherein each of the plurality of storage units is connected to the switch via an I²C bus.
